(19) United States
(12) Patent Application Publication
(10) Pub. No.: US 2008/0203165 A1
(43) Pub. Date: Aug. 28, 2008

(54) DRUG IDENTIFICATION METHOD AND SYSTEM

(75) Inventor: Mark Robert Kohls, New Berlin, WI (US)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, Schenectady, NY (US)

(21) Appl. No.: 11/680,102

(22) Filed: Feb. 28, 2007

(51) Int. Cl. G06K 7/10

(52) U.S. Cl. 235/462.01; 235/472.01

(57) ABSTRACT

A method for conveying information is disclosed herein. The method for conveying information includes providing a drug data bar code having drug data, transferring the drug data bar code to a patient, providing a bar code reader adapted to read the drug data bar code, and implementing the bar code reader to read the drug data bar code and thereby obtain the drug data such that the drug data can be accounted for in a subsequently performed medical procedure. A corresponding system is also provided.

### FIELD OF THE INVENTION

This disclosure relates generally to a method and system for identifying the drugs prescribed to and otherwise taken by a given patient.

### BACKGROUND OF THE INVENTION

Various prescription and non-prescription drugs can impact the data from diagnostic medical procedures. For example, it is well known that certain classes of medications can alter the QT interval of a patient's electrocardiographic data. It is therefore important that a physician be made aware of the specific types and dosages of drugs being administered to a patient prior to the interpretation of any diagnostic medical procedures. The problem is that many patients are not aware of the names and dosages of the drugs they are taking, and the patients are therefore unable to accurately convey this information in a clinically useful manner.

### BRIEF DESCRIPTION OF THE INVENTION

The above-mentioned shortcomings, disadvantages and problems are addressed herein which will be understood by reading and understanding the following specification.

In an embodiment, a method for conveying information includes providing a drug data bar code having drug data, transferring the drug data bar code to a patient, providing a bar code reader adapted to read the drug data bar code, and implementing the bar code reader to read the drug data bar code and thereby obtain the drug data such that the drug data can be accounted for in a subsequently performed medical procedure.

In another embodiment, a method for conveying information includes providing a radio frequency identification tag having drug data, transferring the drug data from the radio frequency identification tag to a radio frequency identification storage device, and retrieving the drug data from the radio frequency identification storage device such that the drug data can be accounted for in a subsequently performed medical procedure.

In another embodiment, a drug identification system includes a patient card, and a drug data bar code attached to the patient card. The drug data bar code includes drug data. The drug identification system also includes a bar code reader configured to read the drug data bar code and thereby obtain the drug data such that the drug data can be accounted for in a subsequently performed medical procedure.

Various other features, objects, and advantages of the invention will be made apparent to those skilled in the art from the accompanying drawings and detailed description thereof.

### BRIEF DESCRIPTION OF THE DRAWINGS

FIG. 1 is a schematic diagram illustrating a drug identification system in accordance with an embodiment; and

FIG. 2 is a schematic diagram illustrating a drug identification system in accordance with another embodiment.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

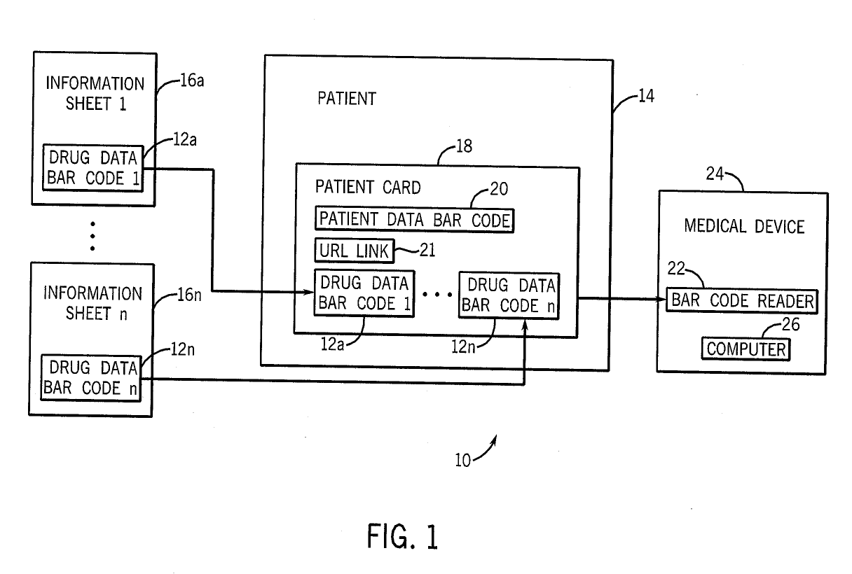

Referring to FIG. 1, a drug identification system 10 is schematically shown in accordance with an embodiment. For purposes of this disclosure, the term “drug” should be interpreted to include prescription medications, over the counter medications, vitamins, nutrition supplements, any other known pharmaceutical substances, as well as implanted devices or biological materials (e.g., bone grafts).

The drug identification system 10 includes one or more drug data bar codes 12a-12n. Each of the drug data bar codes 12a-12n corresponds to a separate drug being administered to the patient 14. Each drug data bar code 12a-12n includes drug data such as the type of drug administered, the recommended dosage, the starting and ending dates for a prescription, the time at which the drug is to be administered, etc.

According to one embodiment, the drug data bar codes 12a-12n are each adhesively applied as peel off labels to an information sheet 16a-16n, respectively. Each of the information sheets 16a-16n corresponds to a separate drug being administered to the patient 14. Each information sheet 16a-16n may include drug data as well as information pertaining to the patient's name, the name of the pharmacy, the name of the prescribing physician, etc. An information sheet 16a-16n may, for example, be issued by a pharmacy when the patient 14 picks up a new prescription, and may be included in the packaging of over the counter drugs.

Each drug data bar code 12a-12n is applied to a patient card 18. According to the embodiment wherein the drug data bar codes 12a-12n are each adhesively applied as peel off labels to an information sheet 16a-16n, the patient 14 can peel off a drug data bar code 12a-12n upon receipt and adhesively apply it to the patient card 18. In this manner, the patient card 18 should ultimately contain a separate drug data bar code 12a-12n for each drug the patient 14 is taking. After the patient 14 stops taking a given drug, the corresponding drug data bar code 12a-12n can be physically removed from the patient card 18 or covered up so that it is not readable.

According to one embodiment, the patient card 18 is wallet sized such that the patient card 18 can be carried in the patient's wallet (not shown) and generally remains with the patient 14 at all times. According to another embodiment, the patient card 18 may optionally include a patient data bar code 20. The patient data bar code 20 contains patient data such as, for example, the patient's name, age, weight, pre-existing medical conditions, allergies, etc. According to yet another embodiment, the patient card 18 may optionally include a uniform resource locator (URL) link 21. The URL link 21 is a link to a server maintained by the patient's pharmacy that contains information such as the types of prescribed medications and the dates at which the prescriptions were filled. In this manner, The URL link 21 can act as a precautionary measure in case, for example, the patient 14 fails to apply one of the drug data bar codes 12a-12n to the patient card 18, or the patient fails to remove or cover up a drug data bar code 12a-12n after he or she stops taking a particular drug. In a non-limiting manner, the URL link 21 may be displayed in plain text on the patient card 18, and/or may be encoded and displayed as a bar code.

When the patient 14 is being treated or cared for, a bar code reader 22 can be implemented to read the drug data bar codes 12a-12n and/or the patient data bar code 20 in order to obtain drug data and/or patient data. The bar code reader 22 may be attached to or incorporated into the design of a medical device 24 configured to diagnose, treat and/or care for the patient 14. In this manner, the bar code reader 22 can obtain any potentially relevant information such as the types and dosages of drugs taken by the patient 14, and generally immediately thereafter the medical device 24 can be implemented to diagnose, treat and/or care for the patient 14 in a manner that accounts for this information. Additionally, the drug data and patient data can be made available to a treating physician so that it can be considered in the analysis of any output from the medical device 24.

The previously described system for obtaining potentially relevant information from the patient card 18 may be implemented in emergency cases wherein the patient 14 is unconscious on incoherent. For example, if an unconscious or incoherent patient arrives at a hospital, staff members could obtain the patient card 18 and scan it in using the bar code reader 22 in order to obtain various forms of potentially relevant or critical data. More precisely, general information pertaining to the patient 14 could be obtained from the patient data bar code 20, and information pertaining to the types and dosages of drugs taken by the patient 14 could be obtained form the drug data bar codes 12a-12n. It can be seen that, in such cases, the patient card 18 is particularly beneficial as it would otherwise be impossible for the unconscious or incoherent patient to convey any information at all.

According to one embodiment, the medical device 24 is an electrocardiograph having a computer 26. By incorporating the bar code reader 22 with the electrocardiograph 24, the computer 26 can automatically account for the types and dosages of drugs taken by the patient 14 when analyzing electrocardiographic data. Therefore, the electrocardiographic data analysis can be more reliable, and the computer 26 can adjust a resultant interpretation based on the drug data. Additionally, the information obtained by the bar code reader 22 from the patient card 18 can be made available to the treating physician when evaluating the electrocardiographic data.

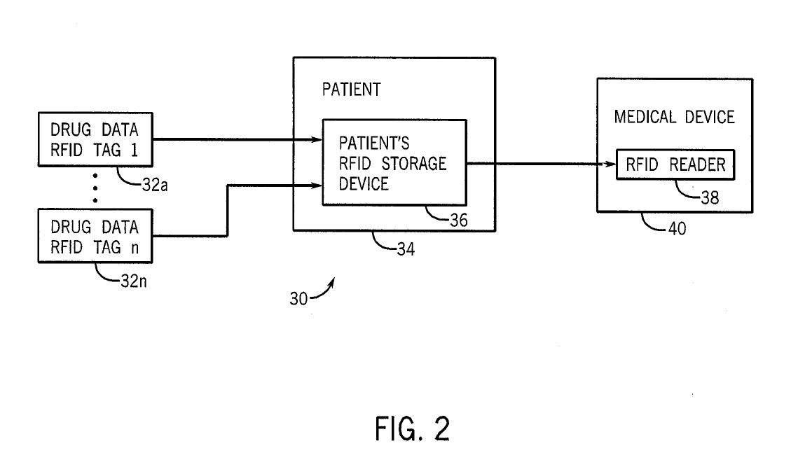

Referring to FIG. 2, a drug identification system 30 is schematically shown in accordance with an embodiment. The drug identification system 30 includes one or more radio frequency identification (RFID) tags 32a-32n. Each of the RFID tags 32a-32n corresponds to a separate drug being administered to the patient 34. Each RFID tag 32a-32n includes drug data such as the type of drug administered, the recommended dosage, the starting and ending dates for a prescription, the time at which the drug is to be administered, etc. The RFID tags 32a-32 may, for example, be independent devices provided with a newly acquired drug, or may be embedded in the container or other packaging of the drug.

The drug data contained in each RFID tag 32a-32 is transferred to an RFID storage device 36. Therefore, the RFID storage device 36 should ultimately contain drug data for each drug the patient 34 is taking. After the patient 34 stops taking a given drug, the corresponding drug data can be erased from the RFID storage device 36. According to one embodiment, the RFID storage device 36 is sufficiently compact that it can conveniently remain with the patient 34 at all times. According to another embodiment, the RFID storage device 36 may optionally include patient data such as the patient's name, age, weight, pre-existing medical conditions, allergies, etc.

When the patient 34 is being treated or cared for, an RFID reader 38 can be implemented to obtain drug data and/or patient data from the RFID storage device 36. The RFID reader 38 may be attached to or incorporated into the design of a medical device 40 configured to diagnose, treat and/or care for the patient 34. In this manner, the RFID reader 38 can obtain information such as the types and dosages of drugs taken by the patient 34, and generally immediately thereafter the medical device 40 can be implemented to diagnose, treat and/or care for the patient 34 in a manner that accounts for this information. Additionally, the drug data and patient data can be made available to a treating physician so that it can be considered in the analysis of any output from the medical device 40.

While the invention has been described with reference to preferred embodiments, those skilled in the art will appreciate that certain substitutions, alterations and omissions may be made to the embodiments without departing from the spirit of the invention. Accordingly, the foregoing description is meant to be exemplary only, and should not limit the scope of the invention as set forth in the following claims.

1. A method for conveying information comprising:
providing a plurality of drug data bar codes each having drug data pertaining to a separate administered drug;
providing a patient data bar code having patient data;
securing the plurality of drug data bar codes and the patient data bar code to a single patient card adapted to fit within a wallet;
providing a bar code reader adapted to read the plurality of drug data bar codes and the patient data bar code; and
implementing the bar code reader to read the plurality of drug data bar codes and the patient data bar code and thereby obtain the drug data and the patient data such that the drug data and the patient data can be accounted for in a subsequently performed medical procedure.

2. The method of claim 1, wherein said providing a plurality of drug data bar codes includes providing a plurality of peel off drug data bar codes.

3. (canceled)

4. The method of claim 1, wherein said securing the plurality of drug data bar codes to a patient card includes adhesively attaching the drug data bar code to the patient card.

5. The method of claim 1, wherein said providing a bar code reader includes providing a bar code reader operatively connected to a medical device.

6. (canceled)

7. (canceled)

8. The method of claim 1, further comprising providing a uniform resource locator link to a server maintained by a pharmacy.

9-14. (canceled)

15. (canceled)

16. (canceled)

17. (canceled)

18. (canceled)

19. (canceled)

20. (canceled)

21. The method of claim 1, wherein said providing patient data bar code includes providing a peel off patient data bar code.

22. The method of claim 1, wherein said securing the patient data bar code to a patient card includes adhesively attaching the patient data bar code to the patient card.
